(19) United States
(12) Patent Application Publication
(10) Pub. No.: US 2026/0007986 A1
(43) Pub. Date: Jan. 8, 2026

(54) METHODS AND SYSTEMS FOR GREENHOUSE GAS CAPTURE AND SEQUESTRATION UTILIZING DIRECT AIR CAPTURE

(71) Applicant: CARBON GEOCYCLE, INC., Laramie, WY (US)

(72) Inventor: John POPE, Laramie, WY (US)

(73) Assignee: CARBON GEOCYCLE, INC., Laramie, WY (US)

(21) Appl. No.: 19/324,428

(22) Filed: Sep. 10, 2025

Related U.S. Application Data
(63) Continuation of application No. PCT/US24/24745, filed on Apr. 16, 2024.
(60) Provisional application No. 63/459,918, filed on Apr. 17, 2023.

(51) Int. Cl. B01D 7/00; B01F 23/237; E21B 43/16

(52) U.S. Cl. CPC B01D 7/00; B01F 23/23762; E21B 43/164

(57) ABSTRACT

Integrating direct air capture techniques in a novel manner with a novel process for using subterranean coal formations to filter CO₂ from mixed gas streams thereby reducing the energy input and cost of removing CO₂ from the atmosphere.

### TECHNICAL FIELD/FIELD OF THE DISCLOSURE

The present disclosure relates to greenhouse gas capture and sequestration in a subterranean formation. More specifically, embodiments are directed towards integrating direct air capture techniques in a novel manner with a novel process for using subterranean coal formations to filter CO₂ from mixed gas streams, thereby reducing the energy input and cost of removing CO₂ from the atmosphere.

### BACKGROUND OF THE DISCLOSURE

Greenhouse gases, such as carbon dioxide, methane, nitrous oxide, and ozone have increased in concentration in the atmosphere. Various methods of point source and non-point source capture of greenhouse gases have been proposed but have traditionally not been economically viable. In traditional processes, greenhouse gases are captured, condensed, and then injected into an underground rock formation. Capture, concentration, and compression of greenhouse gases require intensive energy and capital.

One underground rock formation previously targeted as a sequestration sink was coal. Prior methods to sequester CO₂ into downhole coal formations involved injecting pure CO₂ into coal seams. This sometimes overloads the coal seams with CO₂ and causes the downhole coal seams to swell and subsequently lose connectivity. This can damage the coal formation, and impede further sequestration of CO₂.

Alternatively, CO₂ can be dissolved into water that is then flowed into a subterranean coal seam. The water removes some or all of certain other gases due to their lower solubility and provides a carrier medium that is largely incompressible, and therefore suitable to flow control through the coal using pressure management techniques. Also, the water dilutes the CO₂ and thereby reduces or avoids swelling or other formation damage to the coal during the sequestration process, thereby facilitating further sequestration of CO₂.

Coal is known to preferentially absorb CO₂ over water, nitrogen, methane, and other gases. As a result, a mixed gas stream containing nitrogen and CO₂, for example, that is flowed through coal will sequester CO₂ and not the nitrogen. This natural filtering preference of coal for CO₂ can therefore be used to reduce or eliminate the need to pre-scrub nitrogen and other gases from mixed gas streams intended for sequestration. Because pre-scrubbing of other gases represents the single most capital-intensive step involved in carbon capture and sequestration, reducing, or eliminating it has the effect of making various methods of point source and non-point source capture of greenhouse gases economically viable in more situations.

In the case of non-point sources of CO₂, various methods for capturing and scrubbing CO₂ have from the atmosphere been developed and used for many years including the use of amines, membranes, cryogenic apparatus, and others. Some of the largest energy and capital inputs into those methods involve moving large volumes of air, regenerating sorbent media and/or powering thermal swings, and scrubbing and compressing the resulting gas stream to produce a gas stream suitable for use or sequestration with traditional methods.

By using subterranean coal as a preferential filter for CO₂, it is possible to reduce those energy and capital inputs and thereby make the various methods of non-point source capture of greenhouse gases economically viable in more situations.

Accordingly, needs exist for systems and methods for integrating the process of capturing CO₂ from the air and sequestering it into subterranean coal seams in a manner that realizes the unexpected benefit of lower energy and capital needs. In particular, needs exist for systems and methods of utilizing CO₂ captured from the air using amine, membrane, cryogenic, and other methods that are then dissolved into water and flowed through a coal seam to sequester the CO₂ into the coal.

### SUMMARY

Embodiments of the present disclosure are directed towards utilizing DAC (direct air capture) and sequestering the captured CO₂ into subterranean coal seams. Embodiments of utilizing CO₂ captured from the air may utilize amine, membrane, cryogenic, and other methods, wherein the captured CO₂ is then dissolved into water. The water with dissolved CO₂ may then flow into a coal seam to sequester CO₂ into the coal seam.

For example, in an embodiment utilizing cryogenic DAC, solid CO₂ can be converted to a gas within a constrained volume. The phase change of the solid CO₂ into gas within the constrained volume will result in a compressed, high-pressure gas stream within the constrained volume. The high-pressure gas stream within the constrained volume can then be mixed and subsequently dissolved into water with no further compression to form a mixed gas stream.

Other embodiments may utilize DAC methods to capture CO₂ and dissolve CO₂ into water to form the mixed gas stream. For example, one embodiment may utilize an air-contacting medium containing an amine-based sorbents, and a regeneration segment. The contacting medium may be configured to expose ambient air to the sorbent and enable airflow through the system to increase the adsorption or absorption of the CO₂ in the air. In embodiments, solid-support amines, metal-organic frameworks, or alkali- and alkaline-earth bases (such as Ca(OH)2, KOH, and NaOH) may be utilized as sorbents. However, one may appreciate that any type of sorbent must be configured to capture CO₂ at ambient conditions because it is uneconomical to pressurize, cool, or heat large quantities of air, and the captured energy must be sourced from low carbon- and non-carbon-emitting forms of energy to ensure that more CO₂ is not released to power the capture process than is captured during the capture process (i.e., to attain negative emission).

Other embodiments may perform DAC through membranes, wherein air with CO₂ is flowed through the membrane to capture the CO₂. DAC requires high membrane performances, mainly on gas permeance and selectivity. The gas permeance of a membrane is generally inversely proportional to a membrane thickness. Therefore, the simplest approach to enhance gas flux through a membrane is a thinning of the membrane. However, open space at the permeate side is necessary to release gas after membrane permeation. Therefore, the membrane should be self-sustaining, maintaining its own structure over the open pores on the support layer surface.

Other implementations may utilize an electro-swing process by which CO₂ binds to a nanotube composite upon charging, and is released upon discharge, eliminating the need for thermal energy and producing a high-purity CO₂ stream.

Other embodiments may utilize metal-organic frameworks (MOFs) for DAC. Embodiments may utilize a MOF polymer nanocomposite that is configured to selectively remove CO2 from air streams when air flows past the MOF.

Utilizing any of the above methods, the CO₂ captured via DAC can then be mixed and subsequently dissolved into water to form a mixed gas stream.

Next, the mixed gas stream with CO₂ can be flowed through a coal seam to sequester the CO₂ into coal. Embodiments exploit the unexpected benefits of cryogenic DAC to produce a solid CO₂, which lends itself to the particular needs and capabilities, such as high pressure at ambient temperature, acceptance of dilute CO₂ stream, etc., of geo sequestering of CO₂ into coal seams via dissolution in water. Embodiments also exploit coal, which does not require pure CO₂ to sequester carbon, reliving the demands of many of the processes and energy required to which DAC would otherwise be subjected to.

In specific embodiments, cryogenic DAC may freeze CO₂ into a solid. Cryogenic DAC may use cold energy, thereby minimizing the thermal energy needed for the process while isolating CO₂ from other gases. Subsequently, the solid CO₂ may be converted into a gas within a constrained chamber, which will result in a compressed, high-pressure gas stream of nearly pure CO₂. Next, the gas stream from the chamber can be dissolved into water and injected into a coal seam.

These, and other, aspects of the embodiments will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention, and the invention includes all such substitutions, modifications, additions, or rearrangements.

### BRIEF DESCRIPTION OF THE DRAWINGS

The present disclosure is best understood from the following description and accompanying figures. Various features are not drawn to scale. Dimensions of features may be arbitrarily increased or reduced for clarity of discussion.

FIG. 1 depicts a method utilizing DAC (direct air capture) to inject or dissolve CO₂ into a fluid stream, according to an embodiment.

FIG. 2 depicts a system leveraging Cryogenic DAC (direct air capture) to utilize frozen CO₂ that it implemented for sequestering carbon within a coal seam, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted to facilitate a less obstructed view of these various embodiments of the present disclosure.

### DETAILED DESCRIPTION

The following disclosure provides many different examples for implementing different features of various embodiments. Specific examples of components and arrangements are described to simplify the disclosure. These examples are not limiting. The disclosure may repeat reference numerals or letters in the examples. This repetition is for simplicity and clarity and does not dictate a relationship between the embodiments or configurations.

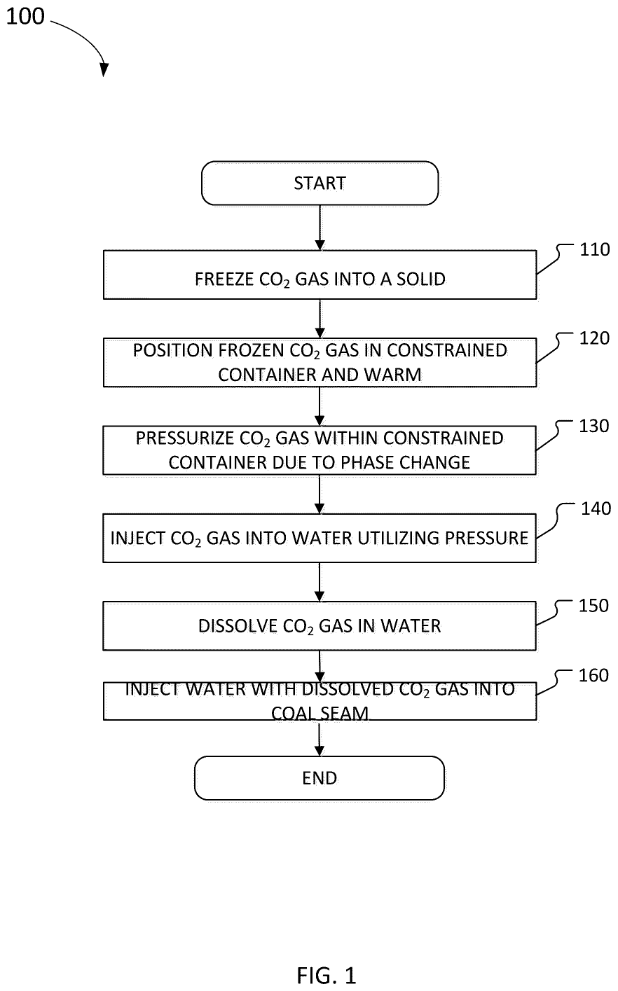

FIG. 1 depicts method 100 utilizing DAC (direct air capture) to inject or dissolve CO₂ into a fluid stream, according to an embodiment. Utilizing DAC to dissolve CO₂ into a mixed gas stream may reduce the energy input to forming the mixed gas stream, enabled by utilizing subterranean coal formations to filter the CO₂ from the mixed gas stream. Embodiments may utilize DAC technologies to extract CO₂ directly from the atmosphere. The CO₂ can be permanently stored in geological formations, thereby achieving carbon dioxide removal (CDR). In embodiments, the medium to extract the CO₂ directly from the atmosphere may be positioned remotely from the geological formations where the CO₂ is subsequently sequestered. A major advantage of DAC is its flexibility, wherein a DAC plant can be situated in any location with low-carbon energy and a CO2 storage resource or CO2 use opportunity. Yet, there may be limits to this flexibility. To date, DAC plants have been successfully operated in various climatic conditions in Europe and North America.

A specific embodiment may utilize Cryogenic DAC to create solid CO₂ that is implemented for sequestering carbon within a coal seam, according to an embodiment. The operations of the method depicted in FIG. 1 are intended to be illustrative. In some embodiments, the method may be accomplished with one or more additional operations not described, and/or without one or more of the operations discussed. Additionally, the order in which the operations of the method are illustrated in FIG. 1 and described below is not intended to be limiting.

At operation 110, cryogenic DAC may freeze gas CO₂ into a solid. Cryogenic DAC may use cold energy, thereby minimizing the thermal energy needed for the process while isolating CO₂ from other gases. In other embodiments, different methods may be utilized to freeze gas CO₂ into a solid. For example, gas CO₂ may be frozen into a solid utilizing altitude, or gas CO₂ may be created utilizing bi-products of compression plants. For example, in a compression gas-processing plant, gas may be successively compressed requiring energy. As the gas is decompressed, the air is cooled—which can be utilized to create the solid CO₂.

At operation 120, the solid CO₂ may be positioned with a constrained container, and the solid CO₂ may be warmed. For example, the solid CO₂ may be warmed due to natural atmospheric temperatures.

At operation 130, due to the phase change of the solid CO₂ into a gas via sublimation, the pressure within the constrained container may increase. This will result in a compressed, high-pressure gas stream of nearly pure CO₂.

At operation 140, the trapped pressure within the constrained container may be utilized to inject the CO₂ gas into a water stream under pressure.

At operation 150, the CO₂ gas may be dissolved into water. In embodiments, the CO₂ may be dissolved within water at a desired concentration, which may be between one and fifteen percent. In embodiments, the amount of CO₂ that may be dissolved within water or medium may be any percentage less than 100%. The desired concentration of the dissolved CO₂ may allow for enough CO₂ to be adsorbed by the coal seam at a desired pressure without damaging the subterranean formation. However, one skilled in the art may appreciate that the CO₂ may be directly captured from the air and injected into the fluid stream in any known method.

At operation 160, the water with dissolved CO₂ may be injected into the coal seam. This may cause the CO₂ to be absorbed within the coal seam and radially push methane away from the face of a coal seam.

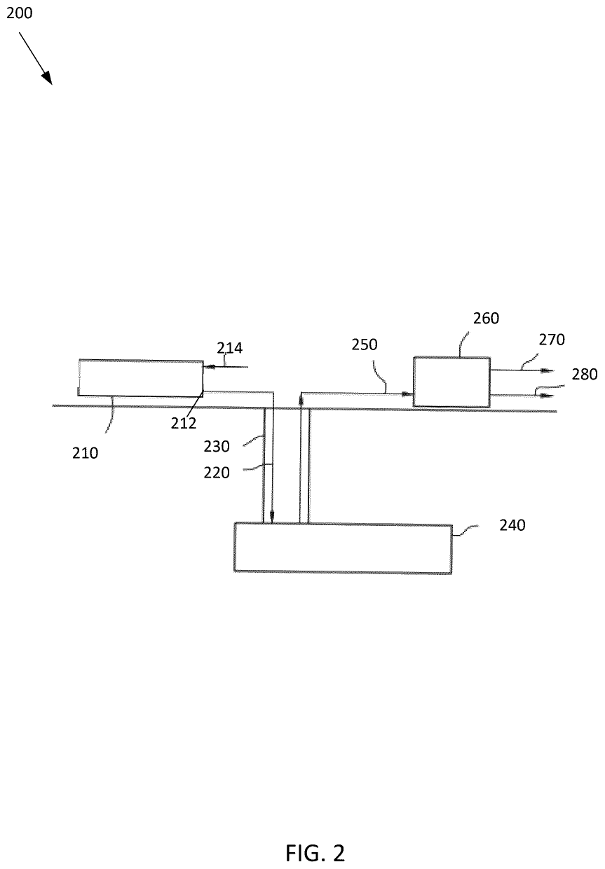

FIG. 2 depicts a system 200 leveraging Cryogenic DAC (direct air capture) to utilize solid CO₂ that it implemented for sequestering carbon within a coal seam, according to an embodiment. As depicted in FIG. 2, system 200 may include a contained chamber 210, fluid piping 220, wellbore 230, and gas sequestration medium 240.

Constrained container 210 may be any type of container with a fixed volume. In embodiments, constrained container 210 may be a tank, storage container, etc. Constrained container 210 may be configured to selectively seal CO₂ within the fixed volume. Constrained container 210 may be configured to receive frozen gas CO₂ in a solid state and allow the solid CO₂ to sublimate into a gas. Responsive to the phase change of the CO₂ with constrained container 210, the pressure within constrained container 210 may increase. This will result in a compressed, high-pressure gas stream of nearly pure CO₂ within constrained container 210. In embodiments, constrained container 210 may include an outlet 212 that is configured to allow the pressurized CO₂ within constrained container 210 to be injected into fluid piping 220. In further embodiments, constrained container 214 may include an inlet, that is configured to receive fluid piping 220, as well as water supplied from fluid piping.

Fluid piping 220 may be tubing configured to transport fluids downhole, such as a fluid stream mixture formed of water of dissolved CO₂ from constrained container 210. Fluid piping 220 may include a first inlet configured to receive first fluids, such as water, and a second inlet that is configured to receive the pressurized CO₂ from constrained container 210. The fluid stream mixture may subsequently travel downhole and into gas sequestration medium 240. In other embodiments, fluid piping 220 may be configured to run directly through constrained container 210, to allow the fluid within fluid piping 220 to receive and dissolve the pressurized CO₂ within constrained container 210. This may allow the CO₂ to be dissolved within a water stream in fluid piping 220 to create a fluid stream mixture, wherein the fluid stream mixture may be created before being injected into wellbore 230 or gas sequestration medium 240. This may allow most of the CO₂ to be dissolved before being injected into wellbore 230 or gas sequestration medium 240. In further embodiments, the percentage of the pressurized CO₂ gas within constrained container 210 that is injected into fluid piping 220 may be increased, slowed, or halted to match the duty cycle of the source or to match the sequestration action of greenhouse gas sequestration medium 150. The concentration of CO₂ within the fluid piping 220 and fluid stream mixture traveling within piping 220 may be controlled by adjusting the flow rate of CO₂ within constrained container 210 or of the water traveling within fluid piping 220. Accordingly, there may be a plurality of ways to impact the amount of CO₂ gas that is dissolved in the fluid stream mixture.

Wellbore 230 may be a hole that is drilled to aid in the exploration and recovery of natural resources, including oil, gas, or water. Wellbore 230 may include greenhouse gas sequestration medium 240 may be a coal seam, whereas greenhouse gas sequestration medium 240 may include a plurality of coal seams at different depths within a single wellbore or multiple wellbores. In an embodiment, the fluid mixture stream within fluid piping 220 may be injected into the coal seam and be used to recover methane from within the porous structure of the coal seam. Without being bound by theory, coal has a greater affinity for CO₂ and nitrogen than for methane. When water having CO₂, such as within the fluid mixture stream, is injected into the coal seam, methane may be liberated and extracted. More specifically, when a fluid mixture stream is injected into greenhouse gas sequestration medium 240, the CO₂ is absorbed by the coal seam, pushing methane ahead within the fracture. The rate and length of the injection, and the location of the production wells, can be chosen to facilitate or eliminate the production of methane from the coal seam. In specific embodiments, appreciative production of methane from the coal seam may be eliminated by halting the injection before the methane reaches a production well, thereby leaving room in the coal for the methane to continue to reside. Further, greenhouse gas sequestration medium 240 could be any target production zone, and the injected solution may be used to enhance the recovery of a variety of hydrocarbons, such as enhanced oil recovery from a mudrock or sandstone reservoir. After sequestration, water containing one or more salts and absorbed hydrocarbon gases, such as natural gas, is transported to the surface through wellbore 230 as produced water stream 250. In other embodiments, the displaced gas may be in a free state depending on the pressure. Produced water stream 250 may be separated in separator 260 into gaseous hydrocarbon stream 270 and separated water stream 280.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art will also understand that such equivalent constructions do not depart from the scope of the present disclosure and that they may make various changes, substitutions, and alterations to the devices disclosed herein without departing from the scope of the present disclosure.

What is claimed is:

1. A method utilizing direct air capture to move CO2 into a fluid stream, the method comprising:
freezing gas CO2 into a solid;
positioning the solid CO2 into a constrained container;
warming the solid CO2;
increasing a pressure within the constrained container;
utilizing the pressure increase within the constrained container to inject the CO2 into a water stream under pressure.

2. The method of claim 1, further comprising:
dissolving the CO2 into the water stream at a desired concentration.

3. The method of claim 2, wherein the desired concentration is between one and fifteen percent.

4. The method of claim 2, wherein the water with the dissolved CO2 is injected into a subterranean formation.

5. The method of claim 4, wherein the injection of the dissolved CO2 into the subterranean formation radially pushes methane away from a face of a coal seam.

6. The method of claim 4, wherein the constrained container includes an inlet, the inlet configured to receive the frozen CO2.

7. The method of claim 6, wherein the frozen CO2 has a phase change within the constrained container to create compressed high-pressure CO2 of nearly pure CO2 within the constrained container.

8. The method of claim 7, wherein the compressed high-pressure CO2 is injected into fluid piping, wherein the fluid piping receives first fluids, the first fluids being water.

9. The method of claim 8, wherein the CO2 dissolves in the first fluids before being injected into the subterranean formation.

10. The method of claim 1, wherein a percentage of the injected CO2 into the water stream is controlled to match a sequestration action of a sequestration medium.
